(19) United States
(12) Patent Application Publication
(10) Pub. No.: US 2011/0120320 A1
(43) Pub. Date: May 26, 2011

(54) COCONUT OPENER DEVICE

(76) Inventor: Ali A. Ukani, Weston, MA (US)

(21) Appl. No.: 12/953,208

(22) Filed: Nov. 23, 2010

Related U.S. Application Data
(60) Provisional application No. 61/264,264, filed on Nov. 25, 2009.

(51) Int. Cl. A23N 5/03

(52) U.S. Cl. 99/576; 99/582; 408/204

(57) ABSTRACT

A coconut opening device for creating an opening in a coconut having a tapered end portion formed in an outer husk surrounding an internal shell housing coconut water. The device includes a motor, shaft, and cutting mechanism. The shaft has a proximal end portion coupled to the motor and a distal end portion connected to the cutting mechanism. The cutting mechanism is rotatable with the shaft when the shaft is rotated by the motor. The cutting mechanism is positionable over the tapered end portion of the husk, and operable when so positioned (and rotated by the motor) to cut an opening in both the husk and the shell to provide access to the coconut water housed inside the shell. The coconut may be positioned by a coconut holder when the opening is cut.

### CROSS REFERENCE TO RELATED APPLICATION(S)

This application claims the benefit of U.S. Provisional Application No. 61/264,264, filed Nov. 25, 2009, which is incorporated herein by reference in its entirety.

### BACKGROUND OF THE INVENTION

1. Field of the Invention

The present invention is directed generally to methods and devices for opening coconuts.

2. Description of the Related Art

FIG. 1 is a cross-section of a young coconut 10. The coconut 10 has a husk 12 surrounding a continuous hard inner shell 14. The shell 14 defines a hollow interior chamber 16 that houses coconut juice or water 18. Coconut flesh or meat 20 is positioned along the inside surface of the shell 14 and surrounds the coconut water 18. The water from “young” coconuts is often consumed as a beverage. Further, the coconut meat 20 may be removed from the inside of the shell 14 and eaten.

Young coconuts are typically sold with an outermost portion of their husks removed. However, the shell of such young coconuts remains completely encased inside the remaining portion of the husk. The remaining portion of the husk is typically shaped in manner that facilitates shipping. Referring to FIG. 1, the remaining portion of the husk 12 of the young coconut 10 may have a pointed or tapered portion “P” opposite a flat or curved base portion “B.” The tapered portion “P” is typically formed along a portion of the coconut referred to as an upper portion. Young coconuts are traditionally opened at their upper portions.

Currently, most people use a knife or cleaver to open young coconuts to obtain the coconut water and/or coconut meat. For example, the tapered portion “P” of the remaining portion of the husk 12 of the young coconut 10 may be removed using a knife to form an opening into the interior chamber 16 of the shell 14. Unfortunately, this conventional approach involves cutting into a hard curved surface with a knife, which carries with it a substantial risk of injury to the person trying to open the coconut. Further, to be successful and avoid injury, this approach requires skill and practice.

Complex coconut opening devices exist but such devices are too complex to be used in a domestic or small business environment. Therefore, a need exists for easier and safer methods of opening coconuts. Methods usable within a home or small business are particularly desired. Further, methods and devices for opening food and beverage items, like coconuts, must be sanitary and safe for use with food. The present application provides these and other advantages as will be apparent from the following detailed description and accompanying figures.

### BRIEF DESCRIPTION OF THE SEVERAL VIEWS OF THE DRAWING(S)

FIG. 1 is cross-section of a young coconut depicting a husk, shell, coconut water, and coconut meat.

FIG. 2 is a cross-section of a coconut holder holding the coconut of FIG. 1 as a coconut opening device cuts an opening in the coconut.

FIG. 3 is an elevational perspective view of the coconut opening device of FIG. 2 illustrated with its enclosure and switch removed.

FIG. 4 is a cross-section of the coconut of FIG. 1 after the coconut opening device of FIG. 2 has cut an opening in the coconut.

FIG. 5 is an alternate embodiment of the coconut opening device.

FIG. 6 is an embodiment of the coconut opening device powered by a removable battery instead of a conventional power cord and plug.

FIG. 7 is a side view of the coconut holder of FIG. 2.

### DETAILED DESCRIPTION OF THE INVENTION

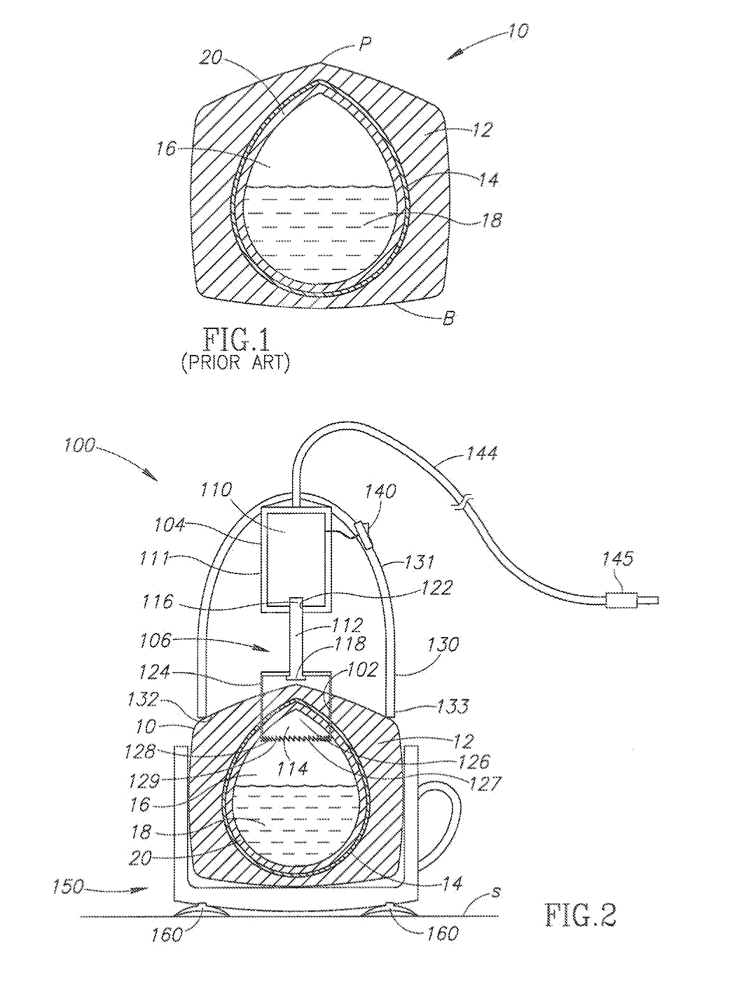

FIG. 2 illustrates a coconut opening device 100 operable to create an opening 102 in the coconut 10 through which the coconut water 18 and/or coconut meat 20 may be extracted. The device 100 may be configured to be handheld and operated by a single operator. Further, the device 100 may be configured to be portable.

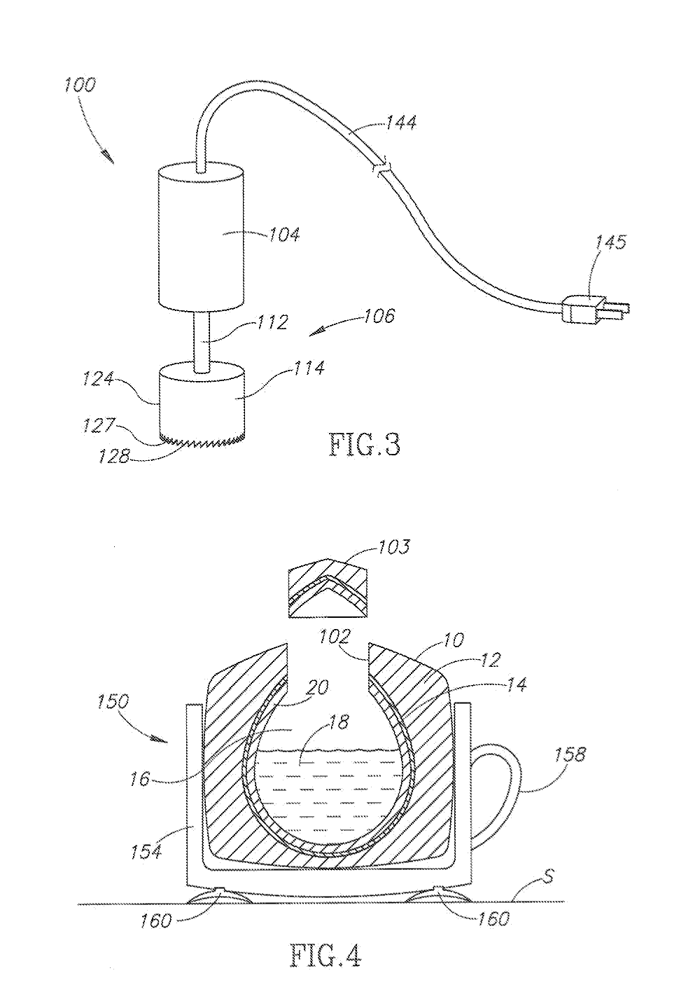

FIG. 4 illustrates the coconut 10 after a portion 103 of the husk 12 and shell 14 has been removed by the device 100 (see FIGS. 2 and 3) to form the opening 102 in the coconut 10. The opening 102 may be generally circularly shaped when viewed from outside the coconut 10. The opening 102 may be large enough to permit a spoon (not shown) to pass therethrough to remove the coconut meat 20 from inside the coconut 10. By way of a non-limiting example, the opening 102 may have a diameter of about one inch. By way of another non-limiting example, the opening 102 may have a diameter that ranges from about one inch to about three inches. By way of yet another non-limiting example, the diameter of the opening 102 can be sized to receive only a single drinking straw (not shown). Alternatively, the opening 102 may be large enough that a spoon (not shown) may be inserted into the opening 102.

Turning to FIGS. 2 and 3, the device 100 includes a motor assembly 104 coupled to and configured to rotate a rotatable cutting assembly 106. Turning to FIG. 2, the motor assembly 104 includes a motor 110 (e.g., a rotary electric motor) that may be housed inside a motor housing 111. The motor housing 111 may be constructed using any material suitable for use with food products, such as plastic, stainless steel, and the like.

The cutting assembly 106 includes a shaft 112 and a cutting mechanism 114. The shaft 112 has a proximal end portion 116 opposite a distal end portion 118. The distal end portion 118 is coupled to the cutting mechanism 114. The proximal end portion 116 is coupled to the motor 110. The cutting mechanism 114 rotates with the shaft 112 as a unit when the shaft 112 is rotated by the motor 110. The motor housing 111 helps isolate the motor 110 from the coconut 10 and pieces of coconut cut from the coconut by the cutting mechanism 114.

The proximal end portion 116 may be permanently coupled to the motor 110. Alternatively, the proximal end portion 116 of the shaft 112 may be selectively attachable to and detachable from the motor 110. For example, the shaft 112 may be detached from the motor 110 for cleaning and reattached for use. When the shaft 112 is coupled to the motor 110, the motor is operable to selectively rotate the shaft 112.

The motor 110 may be implemented using any electric motor capable of applying sufficient torque to the shaft 112 to turn the shaft and the cutting mechanism 114 when the cutting mechanism 114 is engaged with the coconut 10 to form the opening 102 therein. For example, the motor 110 may be implemented as a rotary electric motor. The motor 100 may be implemented as a fixed speed motor, a variable speed motor, and the like. In embodiments in which the motor 110 is implemented using a variable speed motor, the device 100 may include a speed control (not shown) configured to control the speed at which the motor rotates the shaft 112. The speed control (not shown) may be implemented as a button, a dial, a switch, and the like. The motor 110 may be configured for use with food products and may be sized and shaped to be portable and hand operated.

As is apparent to those of ordinary skill in the art, in embodiments in which the motor 110 is implemented as a rotary electric motor, when the motor is turned on, the motor rotates. That rotation is translated to the proximal end portion 116 of the shaft 112. The motor 110 may include an opening 122 configured to receive the proximal end portion 116 of the shaft 112. The motor housing 111 may include an opening adjacent the opening 122 configured to allow the proximal end portion 116 of the shaft 112 to be inserted into (and optionally removed from) the opening 122. In embodiments in which the shaft 112 is selectively attachable to and detachable from the motor 110, the motor includes a connector or coupler (not shown) positioned inside the opening 122 that is operable to selectively couple the proximal end portion 116 of the shaft 112. The coupler (not shown) is further configured to be decoupled from the proximal end portion 116 of the shaft 112. Any coupler suitable for coupling a shaft to a motor and selectively uncoupling a shaft from a motor may be used to construct embodiments of the device 100.

The motor 110 may include a timer (not shown) configured to limit the duration of operation of the motor when the motor is turned on. For example, the duration of operation of the motor 110 may be limited to a predetermined amount of time (e.g., about one minute, about two minutes, and the like).

The shaft 112 is configured to translate sufficient torque from the motor 110 to the cutting mechanism 114. In embodiments in which the shaft 112 is selectively attachable to and detachable from the motor 110, the proximal end portion 116 of the shaft 112 may include a key portion (not shown) or other structure configured to couple with the coupler (not shown) of the motor 110. Any structure suitable for selectively coupling a shaft to a motor and selectively uncoupling a shaft from a motor may be used to construct embodiments of the device 100.

The cutting mechanism 114 may be integrally formed with the shaft 112 or coupled thereto. The cutting mechanism 114 may be permanently or removably coupled to the distal end portion 118 of the shaft 112. By way of an example, any structure suitable for selectively coupling a cutting mechanism to a shaft and selectively uncoupling a cutting mechanism from a shaft may be used to construct embodiments of the device 100. The cutting mechanism 114 illustrated in the drawing is implemented using a conventional hole saw. In such embodiments, the cutting mechanism 114 may be coupled to the shaft 112 using an structure suitable for coupling a hole saw to a shaft for rotation thereby.

The cutting mechanism 114 illustrated has a generally cylindrical shape defined by a continuous outer sidewall 124. The sidewall 124 defines an internal channel 126. Optionally, cutting teeth 127 are formed along a lower edge 128 of the sidewall 124 defining an opening 129 into the internal channel 126. Alternatively, the cutting mechanism 114 may include a sharp blade or a serrated blade positionable against the husk 12 of the coconut 10.

A hole saw provides advantages over using a conventional drill bit because the tapered portion “P” of the coconut 10 may be at least partially received inside the internal channel 126 through the opening 129 adjacent the lower edge 128 of the sidewall 124. Thus, the tapered shaped of the tapered portion “P” may help prevent slippage of the cutting mechanism 114 on the outer surface of the husk 12 of the coconut 10. In contrast, conventional drill bits tend to slide on curved or tapered surfaces. An operator can be injured when a drill bit slips in this manner.

Optionally, the device 100 may include a housing or enclosure 130 that houses the motor 110 and at least a portion of the rotatable shaft 112. The motor 110 may be fixedly and nonrotatably mounted inside the enclosure 130. The enclosure 130 includes a lower portion 133 having an aperture 132 formed therein through which the shaft 112 may extend to position the cutting mechanism 114 outside the enclosure 130 for engagement with the coconut 10. An outside surface 131 of the enclosure is configured to be gripped by the operator when the operator is operating the device 100. Optionally, the outside surface 131 may be textured, include gripping projections, and the like to help the operator grip the enclosure 130. When forming the opening 102 in the coconut 10, the operator may press on the outside surface 131 of the enclosure 130 to press the cutting mechanism 114 against the coconut 10. As illustrated in FIG. 2, when the cutting mechanism 114 has cut through the shell 14 and reached the interior chamber 16, the lower portion 133 of the enclosure 130 may contact or rest upon the coconut 10. Thus, the enclosure 130 may be used to halt the inward movement of the cutting mechanism 114 into the coconut 10.

A switch 140 may be coupled to the enclosure 130. The switch 140 may be operated manually by an operator. The switch 140 is electrically connected to the motor 110 and is operable to selectively turn the motor 110 on and off. Thus, the switch 140 may be selectively positionable in an “on” position to turn the motor 110 on and an “off” position to turn the motor 110 off. When the motor 110 is on, the motor rotates the shaft 112. When the motor 110 is off, the motor does not rotate the shaft 112.

The enclosure 130 and the switch 140 have been omitted from FIG. 3 to provide a better view of the components positioned inside the enclosure 130.

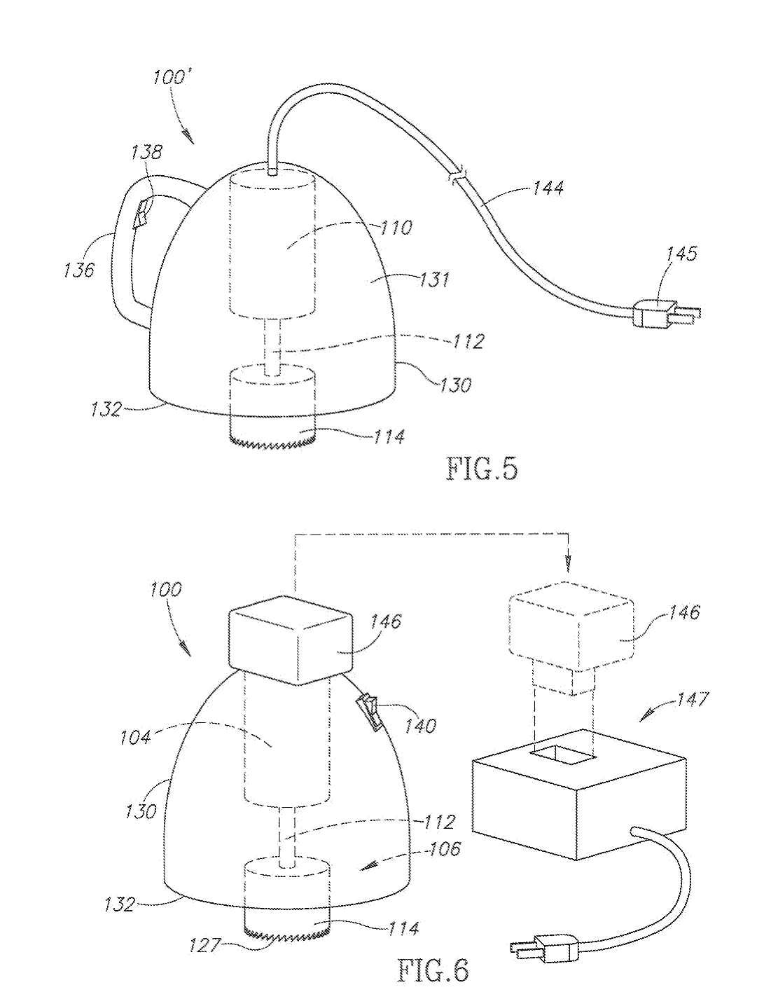

FIG. 5 illustrates a coconut opening device 100′, which is an alternate embodiment of the device 100. In FIGS. 2, 3, and 5, like reference numerals have been used to identify like components of the devices 100 and 100′. In the embodiment illustrated in FIG. 5, the enclosure 130 includes a handle 136 that may be gripped when the device 100 is in use. The handle 136 may help the operator grip the enclosure 130 if the cutting mechanism 114 becomes stuck or binds inside the husk 12 and/or shell 14 of the coconut 10. Optionally, instead of the switch 140 (see FIG. 2), the device 100′ may include a switch 138 that must be pressed continuously for the motor 110 to operate. The switch 138 may be positioned on the handle 136 to allow the switch 136 to be selectively pressed by the operator's hand to turn the motor 110 on and off.

Referring to FIGS. 2, 3, and 5, the device 100 and/or the device 100′ may be powered by a conventional power cord 144 connected to a conventional wall plug 145 that is receivable inside a conventional wall socket (not shown). Alternatively, referring to FIG. 6, the device 100 and/or the device 100′ (see FIG. 3) may be configured to be cordless. In such embodiments, the motor 110 is powered by a removable battery 146 that replaces the power cord 144 and the wall plug 145 illustrated in FIGS. 2, 3, and 5. Optionally, the battery 146 may be rechargeable or disposable. By way of a non-limiting example, the battery 146 may be recharged by a recharging unit 147 configured to be plugged into a conventional wall socket (not shown) to receive power therefrom. By way of another non-limiting example, the recharging unit 147 may include solar panels (not shown) and may be powered by electricity generated by the solar panels.

The device 100 and/or the device 100′ may include a first detection mechanism (not shown) configured to detect when the cutting mechanism 114 is positioned against the coconut 10. If the first detection mechanism detects the cutting mechanism 114 is positioned against the coconut 10, the operator may be able to turn the motor 110 on (e.g., using the switch 140, the switch 138, and the like). On the other hand, if the first detection mechanism fails to detect that the cutting mechanism 114 is positioned against the coconut 10, the operator may be unable to turn the motor 110 on. The first detection mechanism may be implemented using a proximity sensor to detect the device 100 is within a predetermined distance from another object, such as the coconut 10. Alternatively, the first detection mechanism may be implemented as a pressure sensor configured to detect when the cutting mechanism 114 is being pressed against the coconut 10.

The device 100 and/or the device 100′ may include a second detection mechanism (not shown) configured to detect when the cutting mechanism 114 has cut through the shell 14 and is therefore inside the interior chamber 16 of the coconut 10. When the second detection mechanism detects the cutting mechanism 114 has cut through the shell 14, the motor 110 may be turned off automatically. When the second detection mechanism has not detected that the cutting mechanism 114 has cut through the shell 14, the motor 110 may be allowed to rotate the shaft 112. For example, the second detection mechanism may detect the cutting mechanism 114 has cut through the shell 14 by detecting when the motor 110 is applying less torque to the shaft 112. Thus, a reduction in an amount of torque applied by the motor 110 to the shaft 112 may signal that the cutting mechanism 114 has cut through the shell 14. By way of a non-limiting example, the second detection mechanism may detect the cutting mechanism 114 has cut through the shell 14 when the amount of torque applied by the motor 110 to the shaft 112 has reduced by a predetermined amount or is below a threshold value. Alternatively, the second detection mechanism may be implemented as a pressure sensor configured to detect when the cutting mechanism 114 is no longer being pressed against the coconut 10 (e.g., because the cutting mechanism has entered the interior chamber 16), the amount of pressure has reduced by a predetermined amount, or the amount of pressure is less than a threshold value.

The first and second detection mechanisms may be implemented using the same detection mechanism or different detection mechanisms.

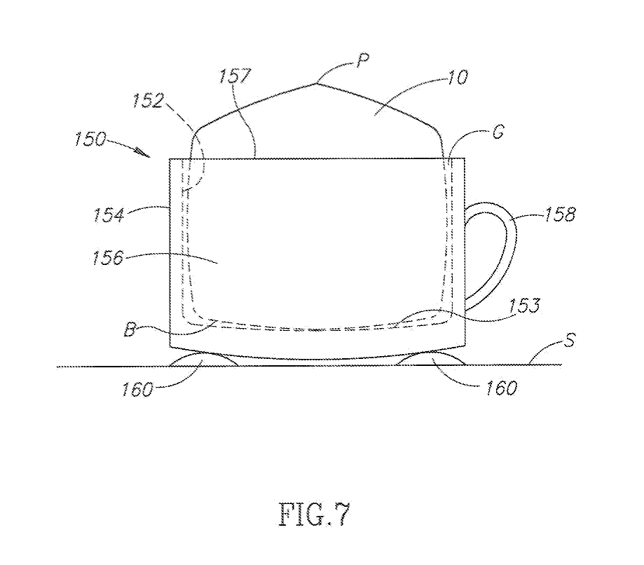

As may best be viewed in FIG. 7, the coconut 10 may be positioned by a coconut holder 150 having a coconut receiving portion 152 configured to receive the base portion “B” of the coconut 10. In the embodiment illustrated, the coconut receiving portion 152 has a base portion 153 upon which the base portion “B” of the coconut 10 rests. A continuous sidewall 154 defining an upwardly opening interior portion 156 extends upwardly from the base portion 153. In the embodiment illustrated, the sidewall 154 is generally cylindrical in shape. Optionally, a gap “G” may exist between the sidewall 154 and the coconut 10 when the coconut 10 is received inside the coconut receiving portion 152. While illustrated as having a cup or bowl shape, the coconut receiving portion 152 may have other shapes suitable for receiving the base portion “B” of the coconut 10. For example, the interior portion 156 may be generally cube shaped or box shaped. Further, instead of being continuous, the sidewall 154 may be implemented as a plurality of sidewalls connected together to define the interior portion 156.

The sidewall 154 has an upper edge 157 opposite the base portion 153. When the coconut 10 is received inside the coconut receiving portion 152, the sidewall 154 helps maintain the coconut in a substantially upright orientation for opening by the device 100 (see FIGS. 2 and 3) or the device 100′ (see FIG. 5). In the embodiment illustrated, the sidewall 154 is configured such that the coconut 10 extends upwardly from the base portion 153 beyond the upper edge 157 of the sidewall to position the tapered portion “P” of the coconut 10 above the upper edge of the sidewall. However, this is not a requirement.

Optionally, the coconut holder 150 may include one or more handles 158. By way of non-limiting examples, the coconut holder 150 may include two handles. The coconut holder 150 may be used to hold the coconut 10 while a user drinks the coconut water 18 (see FIGS. 1, 2, and 4) from the coconut. Optionally, the coconut holder 150 may be configured to hold accessories or other items. For example, the coconut holder 150 may include an integrated straw holder (not shown), a spoon holder (not shown), and the like.

The coconut holder 150 may include suction cups 160 coupled to the underside of the base portion 153 to improve the stability of the coconut holder. The suction cups 160 may be used to at least partially adhere the coconut holder 150 to a support surface “S” (such as a table top, a counter top, and the like).

The enclosure 130 and the coconut holder 150 may be combined into a single integrated assembly.

Returning to FIG. 2, to create the opening 102 in the coconut 10, the operator inserts the coconut 10 into the coconut holder 150. If the shaft 112 is detached from the motor 110, the operator attaches the shaft 112 to the motor 110. For example, the proximal end portion 116 may be inserted into the opening 122 in the motor 110. In embodiments including the conventional power cord 144 and wall plug 145, if the wall plug is not plugged into a wall socket (not shown), the wall plug 145 is inserted into a wall socket (not shown) to power the motor 110.

Then, the cutting mechanism 114 is positioned against the upper portion of the coconut 10. In embodiments in which the cutting mechanism 114 is implemented as a hole saw, the hole saw is placed over the tapered portion “P” of the coconut 10. Then, the motor 110 is turned on. For example, the switch 140 is placed in the “on” position. In embodiments including the switch 138 (see FIG. 5), the switch 138 is pressed to turn the motor 110 on. In embodiments including the first detection mechanism (not shown), the first detection mechanism determines the cutting mechanism 114 is being pressed against the coconut 10 and allows the motor 110 to operate. In embodiments including the second detection mechanism (not shown), the second detection mechanism determines the cutting mechanism 114 has not cut through the shell 14 of the coconut 10 and allows the motor 110 to operate.

As the motor 110 operates, it rotates the shaft 112 and the cutting mechanism 114. The operator may press down on the enclosure 130 or (in embodiments that do not include the enclosure) the motor housing 111 to press the cutting mechanism 114 against the coconut 10 as the cutting mechanism 114 cuts through the husk 12 and/or the shell 14.

When the device 100 cuts completely through the husk 12 and the shell 14 of the coconut 10, the opening 102 is formed and provides access to the coconut water 18 and/or coconut meat 20. Then, the motor 110 is turned off. For example, the switch 140 is placed in the “off” position to discontinue operation of the motor 110. In embodiments including the switch 138 (see FIG. 5), the operator discontinues pressing the switch 138 to turn the motor 110 off. In embodiments including the first detection mechanism (not shown), the first detection mechanism may determine the cutting mechanism 114 is no longer being pressed against the coconut 10 and may terminate operation of the motor 110. In embodiments including the second detection mechanism (not shown), the second detection mechanism determines the cutting mechanism 114 has cut through the shell 14 of the coconut 10 and terminates operation of the motor 110.

The shaft 112 and the cutting mechanism 114 are removed from the opening 102. The shaft 112 and the cutting mechanism 114 may be removed either before or after the motor 110 is turned off (or powered down).

Optionally, after the opening 102 is formed in the coconut 10, the shaft 112 may be detached from the motor 110. For example, the proximal end portion 116 may be removed from the opening 122 in the motor 110. Once removed, the shaft 112 and/or the cutting mechanism 114 may be cleaned. In embodiments in which the cutting mechanism 114 is detachable from the shaft 112, the cutting mechanism 114 may be detached from the shaft 112 and replaced with a different cutting mechanism.

Depending upon the implementation details, the device 100 may be configured to be simple to operate, portable, easy to manufacture, easy to maintain, and/or low cost. Further, the device 100 may be configured to create an opening in a coconut quickly and safely.

The foregoing described embodiments depict different components contained within, or connected with, different other components. It is to be understood that such depicted architectures are merely exemplary, and that in fact many other architectures can be implemented which will achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Accordingly, the invention is not limited except as by the appended claims.

The invention claimed is:

1. An apparatus for creating an opening in a coconut comprising a tapered end portion formed in an outer husk surrounding an internal shell housing coconut water, the apparatus comprising:
a motor;
a shaft comprising a proximal end portion coupled to the motor and a distal end portion opposite the proximal end portion, the shaft being rotatably by the motor; and
a cutting mechanism connected to the distal end portion of the shaft, the cutting mechanism being rotatable with the shaft when the shaft is rotated by the motor, the cutting mechanism being positionable over the tapered end portion formed in the husk of the coconut and operable when so positioned and rotated by the motor to cut an opening in both the husk and the shell to provide access to the coconut water housed inside the shell.

2. The apparatus of claim 1, further comprising:
a gripable enclosure comprising an aperture, the motor being fixedly mounted inside the enclosure with the shaft extending outwardly from the motor and through the aperture to position at least a portion of the cutting mechanism connected to the distal end portion of the shaft outside the enclosure.

3. The apparatus of claim 2 for use by an operator, further comprising:
a switch mounted to the enclosure, the switch being selectively positionable manually by the operator in an on position and an off position, the switch being operably coupled to the motor such that when the switch is positioned in the on position the motor is operable and when the switch is positioned in the off position the motor is inoperable.

4. The apparatus of claim 2 for use by an operator, further comprising:
a handle grippable by the operator coupled to the enclosure; and
a switch mounted to the handle, the switch being in an off position unless pressed by the operator into an on position, the motor being operable only when the switch is pressed into the on position.

5. The apparatus of claim 1, further comprising:
a coconut holder configured to hold the coconut in position for cutting by the cutting mechanism.

6. The apparatus of claim 5, wherein the coconut holder further comprises a handle.

7. The apparatus of claim 1, further comprising:
a battery removably connected to the motor, the battery being configured to provide power to the motor.

8. The apparatus of claim 7, further comprising:
a recharging unit configured to charge the battery when the battery is disconnected from the motor.

9. The apparatus of claim 1, wherein the shaft is selectively attachable to and detachable from the motor.

10. The apparatus of claim 1, wherein the cutting mechanism comprises a hole saw having a continuous sidewall with a distal edge portion, the sidewall defining an interior channel having an opening adjacent the distal edge portion of the sidewall, the tapered end portion of the husk of the coconut being at least partially receivable inside the interior channel through the opening adjacent the distal edge portion of the sidewall.

11. An apparatus for creating an opening in a coconut comprising a tapered end portion formed in an outer husk surrounding an internal shell housing coconut water, the outer husk comprising an outer surface, the apparatus comprising:
a motor assembly comprising a motor housed inside a motor housing; and
a cutting assembly having a first portion extending into the motor housing and rotatably coupled to the motor and a second portion extending away from the motor housing, the motor being operable to rotate the cutting assembly as a unit, the second portion of the cutting assembly comprising a cutting tool having a continuous sidewall with a distal edge portion, cutting teeth being formed along the distal edge portion of the sidewall, the sidewall defining an interior channel having an opening adjacent the cutting teeth, the tapered end portion of the husk of the coconut being at least partially receivable inside the interior channel through the opening adjacent the cutting teeth to help prevent the cutting teeth from sliding on the outer surface of the husk when the cutting assembly is rotated by the motor.

12. The apparatus of claim 11, further comprising:
a grippable enclosure comprising an aperture, the motor housing being fixedly mounted inside the enclosure with the second portion extending away from the motor housing further extending through the aperture of the enclosure to position at least a portion of the cutting tool outside the enclosure.

13. The apparatus of claim 12 for use by an operator, further comprising:
a handle grippable by the operator coupled to the enclosure; and
a switch mounted to the handle, the switch being in an off position unless pressed by the operator into an on position, the motor being operable only when the switch is pressed into the on position.

14. The apparatus of claim 11, further comprising:
a coconut holder configured to hold the coconut in position for cutting by the cutting tool.

15. The apparatus of claim 11, wherein the first portion of the cutting assembly is selectively couplable to and uncouplable from the motor.

16. A system for creating an opening in a coconut comprising a tapered end portion formed in an outer husk surrounding an internal shell housing coconut water, the system comprising:
a motor driven cutting tool configured to cut through the husk and shell of the coconut and remove at least a portion of the tapered end portion of the husk and a portion of the shell adjacent thereto; and
a coconut holder configured to receive the coconut and maintain the coconut in a predetermined orientation, the cutting tool being positionable adjacent the tapered end portion of the husk when the coconut is received inside the coconut holder.

17. The system of claim 16, wherein the motor driven cutting tool comprises a hole saw.

18. The system of claim 16, wherein the coconut holder comprises at least one handle.

19. The system of claim 16 for use with a support surface, wherein the coconut holder is supported by the support surface, and the coconut holder comprises suction cups at least partially adhered to the support surface to help prevent the coconut holder from sliding on the support surface.
